(19) United States
(12) Patent Application Publication
(10) Pub. No.: US 2020/0316844 A1
(43) Pub. Date: Oct. 8, 2020

(54) EMBOSSING APPARATUS AND EMBOSSING METHOD

(71) Applicant: BROTHER KOGYO KABUSHIKI KAISHA, Nagoya-shi, Aichi-ken (JP)

(72) Inventors: Rino KOBAYASHI, Nagoya, Aichi (JP); Masahisa KATO, Nagoya, Aichi (JP); Daisuke ABE, Nagoya, Aichi (JP); Masahiko NAGAI, Nagoya, Aichi (JP); Katsuhisa HASEGAWA, Nagoya, Aichi (JP)

(21) Appl. No.: 16/303,992

(22) PCT Filed: Feb. 16, 2017
(86) PCT No.: PCT/JP2017/005667

§ 371 Date: Nov. 21, 2018

(30) Foreign Application Priority Data
May 23, 2016 (JP) 2016-102632

(51) Int. Cl. B29C 59/02; B29C 59/00

(52) U.S. Cl. CPC B29C 59/022; B29C 59/04; B29C 59/002

(57) ABSTRACT

An embossing apparatus which forms an emboss pattern on a sheet-type workpiece, comprising: a mounting unit on which an embossing pen for embossing is mounted; a transfer mechanism configured to move the workpiece and the mounting unit relative to each other; and a controller configured to control the transfer mechanism, the controller being configured to control the embossing apparatus to: identify a contour of a predetermined shape, set a region offset inward or outward by a predetermined amount from the identified contour of the predetermined shape as an offset region, generate pressing data for use to press part of the workpiece which corresponds to the set offset region, and press the workpiece with the embossing pen according to the generated pressing data.

### CROSS-REFERENCE TO RELATED APPLICATION

This application is a continuation application of International Application No. PCT/JP2017/005667, filed on Feb. 16, 2017, which claims priority from Japanese Patent Application No. 2016-102632, filed on May 23, 2016. The disclosure of the foregoing application is hereby incorporated by reference in its entirety.

### FIELD

The present disclosure relates to an embossing apparatus and embossing method for forming an emboss pattern on a sheet-type workpiece.

### BACKGROUND

Conventionally, embossing is known which forms an emboss pattern on a sheet-type workpiece such as paper. For example, Japanese Utility Model Registration No. 3105746 discloses an embossing template sheet having a cut portion cut into a desired shape. Specifically, Japanese Utility Model Registration No. 3105746 discloses that by overlaying paper, which is a workpiece, on the template sheet and pressing the paper along a contour of the cut portion with an embossing pen having a rounded tip, an emboss pattern conforming to a shape of the cut portion is formed.

In forming an emboss pattern by pressing a workpiece with an embossing pen by following a pattern shape cut in the template sheet, the embossing pen may go up onto the template sheet, for example, by getting over the cut portion in the template sheet. In such a case, a shape of the resulting emboss pattern will deviate from a desired shape, which might result in a poor finish of embossing.

### SUMMARY

The present disclosure has been made in view of the above circumstances and has an object to provide an embossing apparatus and embossing method which can prevent an embossing pen from going up onto a template sheet and give a good finish to embossing.

According to the present disclosure, there is provided an embossing apparatus there is provided an embossing apparatus comprising: a mounting unit on which an embossing pen for embossing is mounted; a transfer mechanism configured to move the workpiece and the mounting unit relative to each other; and a controller configured to control the transfer mechanism, the controller being configured to control the embossing apparatus to: identify a contour of a predetermined shape, set a region offset inward or outward by a predetermined amount from the identified contour of the predetermined shape as an offset region, generate pressing data for use to press part of the workpiece which corresponds to the set offset region, and press the workpiece with the embossing pen according to the generated pressing data.

According to the present disclosure, there is provided an embossing method for forming an emboss pattern on a sheet-type workpiece, comprising: identifying a contour of a predetermined shape; setting a region offset inward or outward by a predetermined amount from the identified contour of the predetermined shape as an offset region; generating pressing data for use to press part of the workpiece which corresponds to the set offset region, and pressing the workpiece according to the generated pressing data.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is an external perspective view showing a configuration example of a processing apparatus according to one embodiment.

FIG. 2 is a block diagram showing a configuration example of the processing apparatus.

FIG. 3 is a block diagram showing a configuration example of a control device.

FIG. 4 is a diagram showing an example of a template sheet.

FIG. 5 is a diagram showing an example of setting an amount of offset.

FIG. 6 is a diagram showing an example of selecting a reference edge (Part 1).

FIG. 7 is a diagram showing an example of selecting a reference edge (Part 2).

FIG. 8 is a diagram showing an example of selecting a reference edge (Part 3).

FIG. 9 is a diagram showing an example of selecting a reference edge (Part 4).

FIG. 10 is a diagram showing an example of setting margins of a template sheet.

FIG. 11 is a diagram showing an example of a mat layout screen.

FIG. 12 is a diagram showing an example of a surface embossing operation selection screen.

FIG. 13 is a diagram showing a state example in which a holding member holding a workpiece is set on the processing apparatus.

FIG. 14 is a diagram showing an example of a scan screen displayed during a cutting process (Part 1).

FIG. 15 is a diagram showing an example of a scan screen displayed during a cutting process (Part 2).

FIG. 16 is a diagram showing an example of a template sheet confirmation screen.

FIG. 17 is a diagram showing an example of a template sheet generation screen.

FIG. 18 is a diagram showing a state example in which a template sheet and workpiece are held by the holding member.

FIG. 19 is a diagram showing a state example in which a support sheet is held by the holding member.

FIG. 20 is a diagram showing a state example in which the holding member holding a template sheet, workpiece, and support sheet is set on the processing apparatus.

FIG. 21 is a diagram showing an example of a scan screen displayed during a pressing process

FIG. 22 is a diagram showing an example of a setting screen

FIG. 23 is a diagram showing an example of an embossing screen.

FIG. 24 is a flowchart showing an example of a template sheet generating process.

FIG. 25 is a flowchart showing an example of a cut data generating process.

FIG. 26 is a flowchart showing an example of an embossing process.

FIG. 27 is a flowchart showing an example of a pressing data generating process.

FIG. 28 is a diagram of a variation, showing an example of setting an offset region (Part 1).

FIG. 29 is a diagram of a variation, showing an example of setting an offset region (Part 2).

FIG. 30 is a diagram of a variation, showing an example of setting an offset region (Part 3).

FIG. 31 is a perspective view of a variation, showing a configuration example of the holding member.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

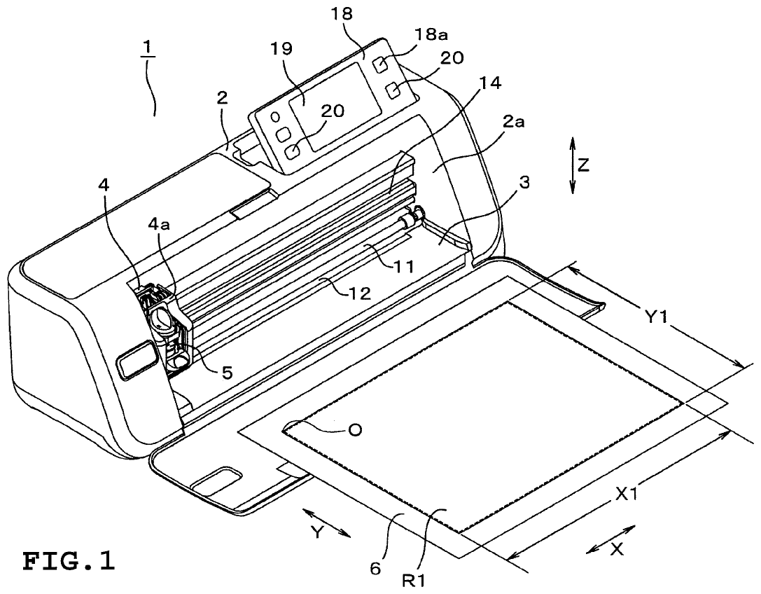

An embodiment according to the present disclosure will be described below with reference to the drawings. A processing apparatus 1 illustrated by example in FIG. 1 is a cutting device adapted to perform cutting to cut a workpiece such as paper. According to the present embodiment, the processing apparatus 1 is used as an embossing apparatus and template sheet generating apparatus according to the present disclosure. When a cutter member is mounted on a carriage 4, the processing apparatus 1 functions as a template sheet generating apparatus adapted to generate a template sheet used in embossing. Also, when an embossing pen is mounted on the carriage 4, the processing apparatus 1 functions as an embossing apparatus adapted to emboss a sheet-type workpiece such as paper.

The processing apparatus 1 includes a body cover 2, a platen 3, and a carriage 4. The platen 3 is provided in lower front part inside the body cover 2. The carriage 4 is an example of a mounting unit on which any of various cartridges 5 is mounted detachably, i.e., replaceably. The cartridge 5 mounted on the carriage 4 can be a cutter cartridge holding a cutter member for cutting, a pen cartridge holding an embossing pen for embossing, and other cartridges. Note that the carriage 4 may be configured to alternatively carry any of various cartridges such as a cutter cartridge and pen cartridge or simultaneously carry plural cartridges.

A holding member 6 is a member used to hold a workpiece for the processing apparatus 1. The holding member 6 includes a base portion shaped like a thin rectangular plate as a whole and an adhesive layer provided on a top surface of the base portion. The adhesive layer has a rectangular shape excluding peripheral edges on four sides of the base portion. At the generation of a template sheet, a base material W1, which is to serve as a material for the template sheet, is separably held by the holding member 6. Also, during embossing, a template sheet W2 and workpiece W3 are separably held by the holding member 6.

The body cover 2 has the shape of a laterally elongated rectangular box, and a front opening 2a is formed on a front face, opening laterally. The holding member 6 is inserted into the processing apparatus 1 through the front opening 2a and set on a top surface of the platen 3. A holding member transfer mechanism is provided inside the body cover 2 to transfer the holding member 6 set on the top surface of the platen 3 in a Y direction, i.e., in a front-rear direction of the processing apparatus 1 in this case. The holding member transfer mechanism includes a pinch roller 11 and drive roller 12 used to pinch the holding member 6 from above and below and transfer the holding member 6 as well as a Y-axis motor 13 adapted to rotate the drive roller 12.

A first carriage transfer mechanism is provided inside the body cover 2 to move the carriage 4 in an X direction, i.e., in a left-right direction of the processing apparatus 1 in this case. The first carriage transfer mechanism includes a guide rail 14 adapted to support the carriage 4 movably in a left-right direction of the processing apparatus 1 and a belt transmission mechanism adapted to transmit a driving force of an X-axis motor 15 and thereby move the carriage 4 in the left-right direction of the processing apparatus 1.

An X-Y coordinate system whose origin O is at a left rear corner of the adhesive layer is established on the holding member 6 and various data including cut data and pressing data described later are generated based on the XY coordinate system. The adhesive layer of the holding member 6 forms a rectangular pasting region R1 measuring “X1” in the X direction, which corresponds to the left-right direction, and “Y1” in the Y direction, which corresponds to the front-rear direction. The pasting region R1 is a cuttable region R1 which enables cutting, i.e., allows a template sheet to be generated using a cutter member, and a pressable region R1 which enables embossing, i.e., allows pressing to be performed using an embossing pen.

An operation panel 18 is provided in right part on the top surface of the body cover 2. The operation panel 18 includes a display 19 which is an example of a display unit and various operation switches 20 which are an example of operating portions. The display 19 is made up, for example, of a liquid crystal display. The display 19 displays various screens needed in generating a template sheet and performing embossing as well as images reproduced from image data obtained by a scanner unit 21 described later. Also, by operating various operation switches 20, the user can enter various commands such as select, change, and run into the processing apparatus 1. Also, a scan button 18a is provided on the operation panel 18 to perform a scan operation using the scanner unit 21 described later. Note that various operating portions such as the operation switches 20 and scan button 18a are not limited to mechanical switches and may be, for example, touch panel switches provided on a surface of the display 19.

The carriage 4 includes a cartridge holder 4a and a second carriage transfer mechanism adapted to move the cartridge holder 4a in a Z direction, i.e., in an up-down direction of the processing apparatus 1 in this case. The Z direction intersects both front-rear direction and left-right direction of the processing apparatus 1 at right angles. The cartridge holder 4a allows various cartridges 5 to be detachably mounted thereon. The second carriage transfer mechanism includes a Z-axis motor 22 and the like, and moves the cartridge holder 4a between a lowered position where processing such as cutting or pressing is performed and a lifted position where the cartridge holder 4a is retracted upward and no processing is performed.

A cutter cartridge, which is an example of the cartridge 5 that can be mounted on the cartridge holder 4a, includes a casing unit extending in the up-down direction and a cutter member extending along a central axis of the casing unit. The cutter member protrudes downward by a predetermined length from a lower end of the casing unit and a cutting edge is provided at a lower end, i.e., at a tip, of the protruding portion. Also, a pen cartridge, which is an example of the cartridge 5 that can be mounted on the cartridge holder 4a, includes a casing unit extending in the up-down direction and an embossing pen extending along a central axis of the casing unit. The embossing pen protrudes downward by a predetermined length from a lower end of the casing unit and a lower end, i.e., a tip, of the protruding portion is rounded. In this case, the carriage 4 can mount multiple types of pen cartridges differing in the diameter of the tip of the embossing pen. Note that, in the present embodiment, the diameter of the rounded tip of the embossing pen may be simply referred to as the “diameter of the embossing pen.”

If a cutter cartridge is mounted on the carriage 4, when the cartridge holder 4a moves to the lowered position, the cutting edge of the cutter member penetrates the workpiece held by the holding member 6 in a thickness direction. This makes it possible to perform cutting of the workpiece. Also, if a pen cartridge is mounted on the carriage 4, when the cartridge holder 4a moves to the lowered position, the tip of the embossing pen abuts and presses a top surface of the workpiece. This makes it possible to perform pressing, i.e., embossing, of the workpiece.

Also, the cartridge holder 4a is provided with a detection sensor 23 adapted to recognize the type of cartridge 5 mounted on the cartridge holder 4a. The detection sensor 23 can identify the type of cartridge 5 mounted on the carriage 4 by reading, for example, code information provided on the cartridge 5 or information stored in an IC chip. Also, the processing apparatus 1 is provided with the scanner unit 21 adapted to read the workpiece held by the holding member 6. In this case, the scanner unit 21 is designed to perform a scan operation when the scan button 18a on the operation panel 18 is pressed by the user. By controlling the holding member transfer mechanism, the processing apparatus 1 performs a scan operation while moving an object to be scanned held by the holding member 6 rearward on the processing apparatus 1.

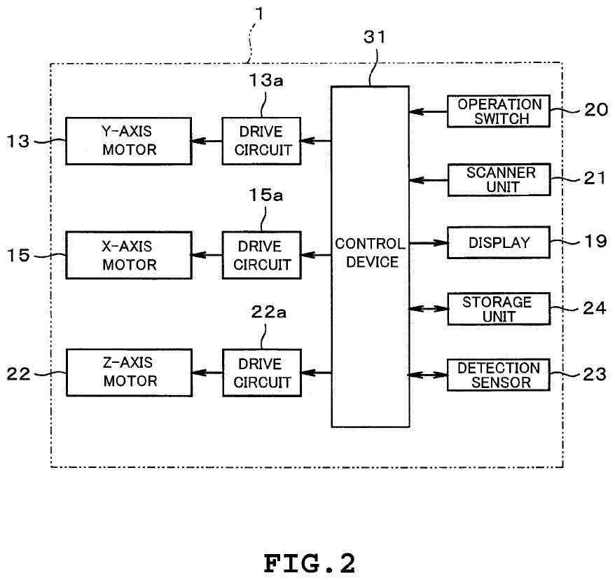

Next, a configuration example of a control system of the processing apparatus 1 will be described with reference to FIG. 2. A control device 31 is mainly made up of a CPU, and controls overall operation of the processing apparatus 1. The control device 31 functions as an example of a control unit adapted to control various transfer mechanisms including a holding member transfer mechanism, a first carriage transfer mechanism, and a second carriage transfer mechanism. The control device 31 is connected with the display 19, various operation switches 20, scanner unit 21, detection sensor 23, and the like. Also, the control device 31 is connected with a storage unit 24 made up of a ROM, RAM, EEPPOM, and the like. Also, the control device 31 is connected with a drive circuit 15a used to drive the X-axis motor 15, a drive circuit 13a used to drive the Y-axis motor 13, and a drive circuit 22a used to drive the Z-axis motor 22.

The storage unit 24 stores various programs including an operation control program used to control various processing operations such as a cutting operation and pressing operation, a processing data generating program used to generate various items of processing data, and a display control program used to control displays on the display 19. The processing data generated by the processing data generating program includes, for example, cut data and pressing data described later. Also, the storage unit 24 stores data and the like needed for various processing. Also, the storage unit 24 stores plural items of emboss pattern data representing various emboss patterns. Also, the storage unit 24 stores various cut data including cut data generated in advance, for example, during manufacturing of the processing apparatus 1 and cut data newly generated on the processing apparatus 1. Also, the storage unit 24 stores various pressing data including pressing data generated in advance, for example, during manufacturing of the processing apparatus 1 and pressing data newly generated on the processing apparatus 1. Also, the storage unit 24 stores, embossing pen/offset amount association data associating the types of embossing pens with amounts of offset. Various programs such as the operation control program and processing data generating program are not limited to those stored in advance in the storage unit 24, and may be those recorded, for example, in external recording media such as an optical disc and configured to be read out of the recording media. Furthermore, programs may be downloaded from outside via a network.

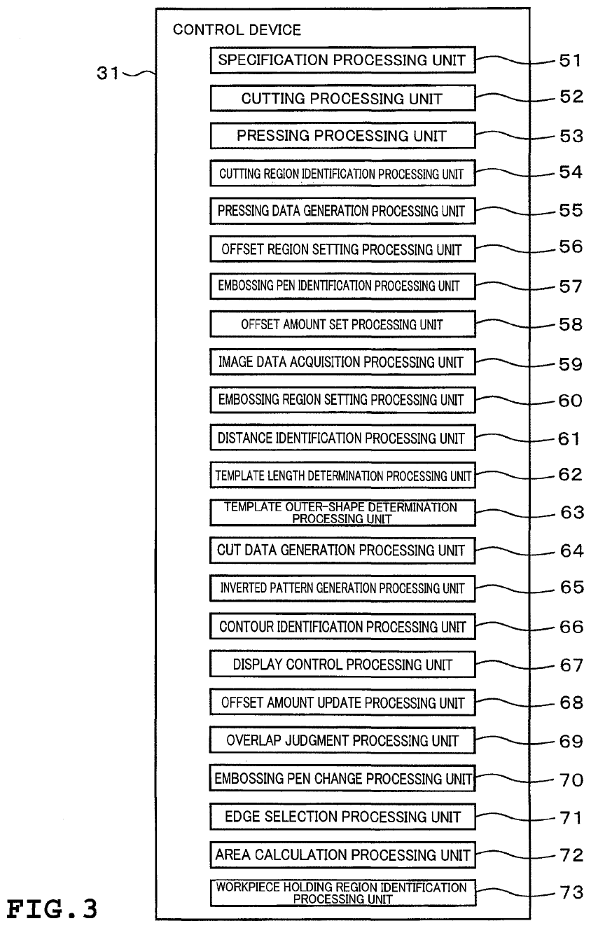

As illustrated by example in FIG. 3, when the operation control program is executed by the CPU, the control device 31 virtually implements, via software, a specification processing unit 51, a cutting processing unit 52, a pressing processing unit 53, a cutting region identification processing unit 54, a pressing data generation processing unit 55, an offset region setting processing unit 56, an embossing pen identification processing unit 57, an offset amount set processing unit 58, an image data acquisition processing unit 59, an embossing region setting processing unit 60, a distance identification processing unit 61, a template length determination processing unit 62, a template outer-shape determination processing unit 63, a cut data generation processing unit 64, an inverted pattern generation processing unit 65, a contour identification processing unit 66, a display control processing unit 67, an offset amount update processing unit 68, an overlap judgment processing unit 69, an embossing pen change processing unit 70, an edge selection processing unit 71, an area calculation processing unit 72, and a workpiece holding region identification processing unit 73. Note that the control device 31 may build these processing units either by hardware or by a combination of software and hardware.

The specification processing unit 51, which is an example of a specification section, specifies an emboss pattern to be formed on the workpiece W3 based on operation input from the user. By controlling various transfer mechanisms including the holding member transfer mechanism, the first carriage transfer mechanism, and the second carriage transfer mechanism, the cutting processing unit 52, which is an example of a cutting section, cuts the emboss pattern specified by the specification processing unit 51 out of the template sheet W2 using the cutter member of the cutter cartridge mounted on the carriage 4. By controlling various transfer mechanisms including the holding member transfer mechanism, the first carriage transfer mechanism, and the second carriage transfer mechanism, the pressing processing unit 53, which is an example of a pressing section, presses the part of the workpiece W3 placed on the template sheet W2 which corresponds to a cutting region R2 cut out by the cutting processing unit 52, using the embossing pen of the pen cartridge mounted on the carriage 4.

The cutting region identification processing unit 54, which is an example of a cutting region identification section, identifies a position and shape of the cutting region R2 in the pressable region R1 which can be pressed by the pressing processing unit 53. The pressing data generation processing unit 55, which is an example of a pressing data generating section generates pressing data used to press the workpiece W3, based on the position and shape of the cutting region R2 identified by the cutting region identification processing unit 54. The pressing processing unit 53 presses the workpiece W3 based on the pressing data generated by the pressing data generation processing unit 55.

The offset region setting processing unit 56, which is an example of an offset region setting section, sets a region offset inward by a predetermined amount from a contour of the cutting region R2 identified by the cutting region identification processing unit 54 as an offset region R3. When the offset region R3 is set by the offset region setting processing unit 56, the pressing data generation processing unit 55 generates pressing data used to press the part of the workpiece W3 which corresponds to the offset region R3 set by the offset region setting processing unit 56. More specifically, the pressing data generation processing unit 55 generates pressing data used to press a contour of the offset region R3. The embossing pen identification processing unit 57, which is an example of an embossing pen identification section, identifies the type of the pen cartridge mounted on the carriage 4, in other words, the type of the embossing pen mounted on the carriage 4, based on detection results produced by the detection sensor 23.

The offset amount set processing unit 58, which is an example of an offset amount setting section, sets the amount of offset used in setting the offset region R3, according to the type of pen cartridge identified by the embossing pen identification processing unit 57, i.e., the type of embossing pen. When the amount of offset is set by the offset amount set processing unit 58, the offset region setting processing unit 56 sets a region offset inward by the amount of offset set by the offset amount set processing unit 58 from the contour of the cutting region R2 identified by the cutting region identification processing unit 54 as the offset region R3. In this case, the offset amount set processing unit 58 is configured to increase the amount of offset according to the diameter of the embossing pen in the pen cartridge identified by the embossing pen identification processing unit 57.

The image data acquisition processing unit 59, which is an example of an image data acquisition section, acquires image data for reproducing an image of the template sheet W2 from which an emboss pattern has been cut out by the cutting processing unit 52. In this case, the image data acquisition processing unit 59 acquires the image data using the scanner unit 21. When image data is acquired by the image data acquisition processing unit 59, the cutting region identification processing unit 54 identifies the position and shape of the cutting region R2 in the pressable region R1 based on the image reproduced from the image data acquired by the image data acquisition processing unit 59. Also, the image data acquisition processing unit 59 acquires image data for reproducing an image of the holding member 6 holding the workpiece W3. The image data acquisition processing unit 59 acquires this data using the canner unit 21.

The embossing region setting processing unit 60, which is an example of an embossing region setting section, sets that region of the workpiece W3 in which an emboss pattern will be formed, as an embossing region R4. The embossing region R4 is, for example, a rectangular region containing an emboss pattern and is set as a region with a margin of a predetermined length from the emboss pattern. The distance identification processing unit 61, which is an example of a distance identification section, identifies a distance from the embossing region R4 set by the embossing region setting processing unit 60 to an edge of the workpiece W3. The template length determination processing unit 62, which is an example of a template length determination section, determines the length of the template sheet W2 to be generated, based on the distance identified by the distance identification processing unit 61, i.e., the distance between the embossing region R4 and the edge of the workpiece W3. The template length determination processing unit 62 can determine a length equal to or longer than the distance identified by the distance identification processing unit 61, as the length of the template sheet. In this case, the template length determination processing unit 62 is designed to determine the length of the template sheet W2 to be generated by adding margins m2 and m3 to a length La described later and doubling the resulting sum.

The template outer-shape determination processing unit 63, which is an example of a template outer-shape determination section, determines an outer shape having the length determined by the template length determination processing unit 62, as an outer shape of the template sheet to be generated. The cut data generation processing unit 64, which is an example of a cut data generating section, generates cut data used to form the cutting region R2 in the shape of the emboss pattern by cutting the template sheet W2 having the outer shape determined by the template outer-shape determination processing unit 63 out of the template sheet base material W1 and cutting the emboss pattern specified by the specification processing unit 51 out of the template sheet W2. Based on the cut data generated by the cut data generation processing unit 64, the cutting processing unit 52 generates the template sheet W2 from which an emboss pattern has been cut out, i.e., the template sheet W2 having the cutting region R2 in the shape of the emboss pattern.

The inverted pattern generation processing unit 65, which is an example of an inverted pattern generating section, generates an inverted pattern by inverting the emboss pattern specified by the specification processing unit 51 in such a way as to be axisymmetric with respect to a predetermined reference line. When an inverted pattern is generated by the inverted pattern generation processing unit 65, the template outer-shape determination processing unit 63 determines a length twice or more as long as the length determined by the template length determination processing unit 62, as the length of the template sheet W2. Then, the cut data generation processing unit 64 generates cut data used to cut the template sheet W2 having the outer shape determined by the template outer-shape determination processing unit 63 out of the template sheet base material W1 and cut the cutting region R2 in the shape of the emboss pattern specified by the specification processing unit 51 and the cutting region R2 in the shape of an inverted pattern generated by the inverted pattern generation processing unit 65 from the template sheet W2. Then, based on the cut data generated by the cut data generation processing unit 64, the cutting processing unit 52 generates the template sheet W2 from which an emboss pattern and inverted pattern have been cut out, i.e., the template sheet W2 having the cutting region R2 in the shape of the emboss pattern and the cutting region R2 in the shape of the inverted pattern.

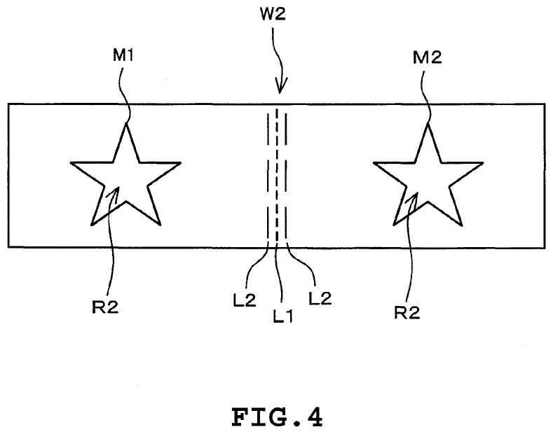

FIG. 4 shows an example of the template sheet W2 generated in this way. That is, the cut data generation processing unit 64 generates cut data to cut the template sheet W2 large enough to sandwich the workpiece W3 when folded from the template sheet base material W1. Then, based on the cut data generated by the cut data generation processing unit 64, an emboss pattern M1 and an inverted pattern M2 are cut out by the cutting processing unit 52 and a template sheet large enough to sandwich the workpiece W3 is generated.

Also, the cut data generation processing unit 64 makes a bending reference line formation data included in the cut data, where the bending reference line formation data is configured to serve as a reference in bending the template sheet W2 and used to form a bending reference line L1 at that position on the template sheet W2 which corresponds to the reference line. In this case, the bending reference line L1 is formed by being cut in the form of a so-called tear-off line. Also, an incision making up the bending reference line L1 is designed not to extend to edges of the template sheet W2. Consequently, the edges of the template sheet W2 is less likely to be cut by the incision making up the bending reference line L1. Note that the bending reference line L1 may be produced by cutting only a surface layer of the template sheet W2 using a so-called half-cut function without piercing the template sheet W2.

Also, the cut data generation processing unit 64 makes an alignment reference line formation data included in the cut data, where the alignment reference line formation data is used in forming alignment reference lines L2, which in turn are used to align the workpiece W3 with the template sheet W2. In this case, the alignment reference lines L2 are formed by being cut in the form of so-called tear-off lines. Also, the alignment reference lines L2 are made up of coarser tear-off lines than is the bending reference line L1 and plural tear-off lines are placed on opposite sides of the bending reference line L1 at equal distances from opposite edges of the template sheet W2. Also, incisions making up the alignment reference lines L2 are designed not to extend to edges of the template sheet W2. Consequently, the edges of the template sheet W2 is less likely to be cut by the incisions making up the alignment reference line L2. Note that the alignment reference lines L2 may be produced by cutting only a surface layer of the template sheet W2 using a so-called half-cut function without piercing the template sheet W2. Note that the alignment reference lines L2 may be made up of tear-off lines of the same form as the bending reference line L1.

The contour identification processing unit 66 which is an example of a contour identification section, identifies a predetermined shape, which, in this case, is a contour of the emboss pattern specified by the specification processing unit 51. The contour identification processing unit 66 can identify the contour of the emboss pattern based on the emboss pattern data of the specified emboss pattern. The contour identification processing unit 66 can also identify the contour of the emboss pattern by analyzing the image of the template sheet W2 from which the emboss pattern has been cut out, the image being reproduced from the image data acquired by the image data acquisition processing unit 59. When the contour of the emboss pattern is identified by the contour identification processing unit 66, the offset region setting processing unit 56 sets a region offset inward or outward by a predetermined amount from the contour of the emboss pattern identified by the contour identification processing unit 66 as the offset region R3. Then, the pressing data generation processing unit 55 generates pressing data used to press the part of the workpiece W3 which corresponds to the offset region R3 set by the offset region setting processing unit 56. Then, the pressing processing unit 53 presses the workpiece W3 based on the pressing data generated by the pressing data generation processing unit 55.

When the amount of offset is set by the offset amount set processing unit 58 according to the type of embossing pen, the offset region setting processing unit 56 sets a region offset inward or outward by the amount of offset set by the offset amount set processing unit 58 from the contour of the emboss pattern identified by the contour identification processing unit 66 as the offset region R3. In this case, again, the offset amount set processing unit 58 is configured to increase the amount of offset according to the diameter of the embossing pen in the pen cartridge identified by the embossing pen identification processing unit 57. Also, when the contour of the emboss pattern is identified by the contour identification processing unit 66, the offset region setting processing unit 56 can set the offset region R3 by partially changing the amount of offset from the contour of the emboss pattern identified by the contour identification processing unit 66.

The display control processing unit 67 is an example of a display control section. Upon accepting a change in the type of embossing pen via an operation switch 20, the display control processing unit 67 changes the amount of offset displayed on the display 19 to an amount of offset stored in the storage unit 24 by being associated with the type of embossing pen resulting from the change. The offset amount update processing unit 68 is an example of an offset amount update section. With the type of embossing pen being displayed on the display 19, upon accepting a change in the amount of offset via an operation switch 20, the offset amount update processing unit 68 updates the amount of offset stored in the storage unit 24 by being associated with the type of embossing pen with the post-change offset amount.

That is, when the type of embossing pen is changed by the user on a setting screen G11 described later, the amount of offset corresponding to the post-change embossing pen is displayed automatically. Also, when the amount of offset is changed by the user on the setting screen G11, the amount of offset corresponding to the embossing pen is updated with the post-change offset amount.

The overlap judgment processing unit 69, which is an example of an overlap judging section, determines whether outlines of the offset region R3 set by the offset region setting processing unit 56, i.e., offset lines L10, overlap each other. Note that the offset lines L10 are imaginary lines formed by offsetting some of plural points which make up a contour of the specified emboss pattern M1 by a predetermined amount and linking together the offset plural points.

The embossing pen change processing unit 70 is an example of an embossing pen changing section. If it is determined by the overlap judgment processing unit 69 that the outlines of the offset region R3 overlap each other, the embossing pen change processing unit 70 performs the process of changing the type of an embossing pen to be mounted on the carriage 4. Conceivable examples of this process include a notification process of prompting the user to change the embossing pen. The notification process may have a notification mode in which a display output is produced via the display 19, a notification mode in which an audio output is produced via an audio output section if the processing apparatus 1 is provided with the audio output section such as a buzzer or speaker, or a notification mode made up of a combination of a display output and audio output. Also, if the processing apparatus 1 is provided with an exchange mechanism for exchanging the cartridge 5 to be mounted on the carriage 4, the pen cartridge may be exchanged automatically by driving the exchange mechanism.

Also, when it is determined by the overlap judgment processing unit 69 that the outlines of the offset region R3 overlap each other, the offset region setting processing unit 56 can set a modified offset region R3s obtained by making the amount of offset of part in which the outlines are determined to overlap smaller than the amount of offset of part in which the outlines are determined not to overlap. Also, when it is determined by the overlap judgment processing unit 69 that the outlines of the offset region R3 overlap each other, the offset region setting processing unit 56 can set a modified offset region R3s containing a line Lc connecting two intersection points formed by the outlines of the offset region R3 in the part in which the outlines overlap each other. In this case, the line Lc contained in the modified offset region R3s passes between the two outlines in the location where the outlines of the offset region R3 overlap each other. Also, the line Lc is formed when the amount of offset in the part of the once established offset region R3 in which the outlines are determined to overlap is made smaller than the amount of offset in the part in which the outlines are determined not to overlap. When the modified offset region R3s is set by the offset region setting processing unit 56 in this way, the pressing data generation processing unit 55 generates pressing data used to press the part of the workpiece W3 which corresponds to the modified offset region R3s resulting from modification by the offset region setting processing unit 56.

The edge selection processing unit 71, which is an edge selecting section, selects an edge for use as a reference in generating the template sheet W2 from among plural edges of the workpiece W3 as a reference edge. When a reference edge is selected by the edge selection processing unit 71, the distance identification processing unit 61 identifies the distance from the embossing region R4 set by the embossing region setting processing unit 60 to the reference edge selected by the edge selection processing unit 71. Then, the template length determination processing unit 62 determines the length of the template sheet W2 based on the distance between the embossing region R4 and the reference edge, the distance having been identified by the distance identification processing unit 61.

The area calculation processing unit 72, which is an example of an area calculating section, calculates the area of a template sheet coverage region R5 including the embossing region R4 set by the embossing region setting processing unit 60 based on the length determined by the template length determination processing unit 62. When the area of the template sheet coverage region R5 is calculated by the area calculation processing unit 72, the edge selection processing unit 71 selects an edge which minimizes the area of the template sheet coverage region R5 calculated by the area calculation processing unit 72, as a reference edge. Also, the edge selection processing unit 71 can select an edge which minimizes the length determined by the template length determination processing unit 62 as a reference edge.

The workpiece holding region identification processing unit 73 is an example of a workpiece holding region identification section. When image data for reproducing an image of the holding member 6 holding the workpiece W3 is acquired by the image data acquisition processing unit 59, the workpiece holding region identification processing unit 73 identifies a workpiece holding region R6 in which the workpiece W3 is held, based on the image reproduced from the acquired image data. When the workpiece holding region R6 is identified by the workpiece holding region identification processing unit 73, the embossing region setting processing unit 60 sets the embossing region R4 in the workpiece holding region R6 identified by the workpiece holding region identification processing unit 73. Then, the distance identification processing unit 61 sets an edge of the workpiece holding region R6 identified by the workpiece holding region identification processing unit 73, as an edge of the workpiece W3. Then, the distance identification processing unit 61 identifies the distance from the embossing region R4 to the edge of the workpiece W3, i.e., to the edge of the workpiece holding region R6.

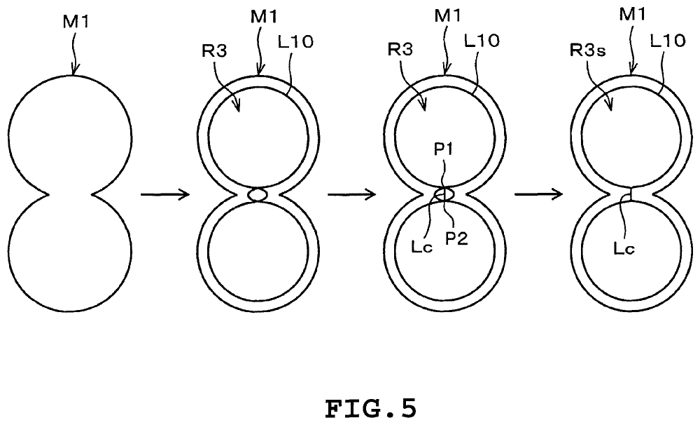

Next, the above-mentioned offset amount adjustment will be described in more detail. The emboss pattern M1 illustrated by example in FIG. 5 has a shape obtained, for example, by coupling together plural—two in this case—circular portions, and if a contour of such a shape is offset inward, the offset lines L10, which are the outlines of the offset region R3, may partially overlap each other. If the offset lines L10 partially overlap each other in this way, the control device 31 establishes a line Lc linking together two intersecting points P1 and P2 formed by the offset lines L10 in a location where the offset lines L10 overlap. In this case, the line Lc passes between the two offset lines L10 in the location where the offset lines L10 overlap each other. Then, the control device 31 sets a region containing the line Lc—a region obtained by coupling together two circular regions via the line Lc in this case—as the modified offset region R3s.

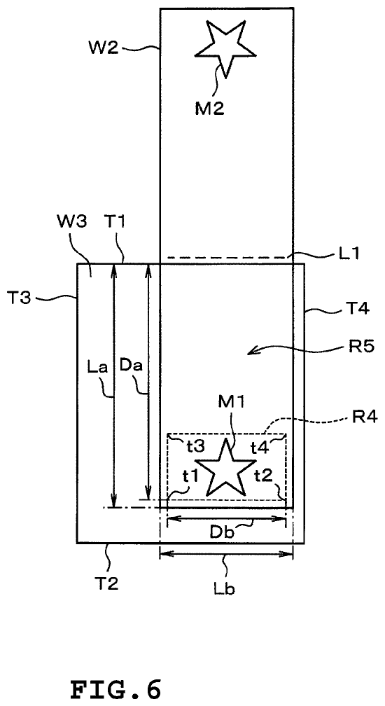

Next, description will be given of an example of selecting a reference edge from plural edges of the workpiece W3. As illustrated by example in FIGS. 6 to 9, when the workpiece W3 is, for example, rectangular, the workpiece W3 has plural, i.e., four edges T1 to T4, and thus there are four candidates for an edge for use in generating the template sheet W2. Then, the distances from the embossing region R4 to be established to the four edges T1 to T4 vary from one to another. Therefore, the length, and even the area, of the template sheet W2 to be generated will vary with the edge selected as the reference edge.

Thus, the control device 31 determines the length of the template sheet by identifying the distances from the embossing region R4 to the edges T1 to T4 with reference to each of the plural edges of the workpiece W3. In so doing, the control device 31 determines the length obtained by offsetting the identified distance by a predetermined amount as the length of the template sheet W2.

That is, the template sheet W2 illustrated by example in FIG. 6 is a type which sandwiches the workpiece W3 from the side of the edge T1. In this case, the control device 31 identifies a distance Da between an edge (an edge t1 or edge t2 on the side opposite the edge T1, in this case) of the embossing region R4 and an edge (the edge T1, in this case) of the workpiece W3 as well as a distance Db between the edge t1 and edge t2 of the embossing region R4. Then, the control device 31 offsets the identified distance Da by a predetermined amount and offsets the identified distance Db by a predetermined amount. Then, the control device 31 multiplies the length La obtained by offsetting the distance Da by a predetermined amount and a length Lb obtained by offsetting the distance Db by a predetermined amount by each other, and thereby calculates the area of the template sheet coverage region R5 including the embossing region R4.

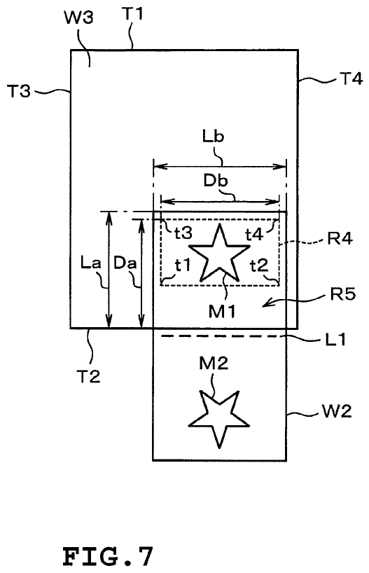

Also, the template sheet W2 illustrated by example in FIG. 7 is a type which sandwiches the workpiece W3 from the side of the edge T2. In this case, the control device 31 identifies a distance Da between an edge (an edge t3 or edge t4 on the side opposite the edge T2, in this case) of the embossing region R4 and an edge (the edge T2, in this case) of the workpiece W3 as well as a distance Db between the edge t3 and edge t4 of the embossing region R4. Then, the control device 31 multiplies the length La obtained by offsetting the distance Da by a predetermined amount and a length Lb obtained by offsetting the distance Db by a predetermined amount by each other, and thereby calculates the area of the template sheet coverage region R5 including the embossing region R4.

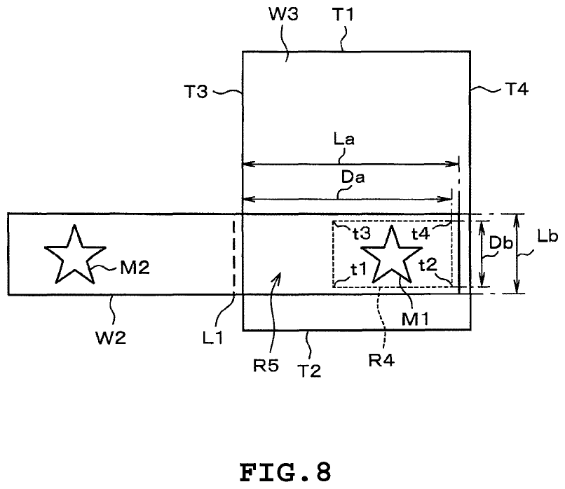

Also, the template sheet W2 illustrated by example in FIG. 8 is a type which sandwiches the workpiece W3 from the side of the edge T3. In this case, the control device 31 identifies a distance Da between an edge (an edge t2 or edge t4 on the side opposite the edge T3, in this case) of the embossing region R4 and an edge (the edge T3, in this case) of the workpiece W3 as well as a distance Db between the edge t2 and edge t4 of the embossing region R4. Then, the control device 31 multiplies the length La obtained by offsetting the distance Da by a predetermined amount and a length Lb obtained by offsetting the distance Db by a predetermined amount by each other, and thereby calculates the area of the template sheet coverage region R5 including the embossing region R4.

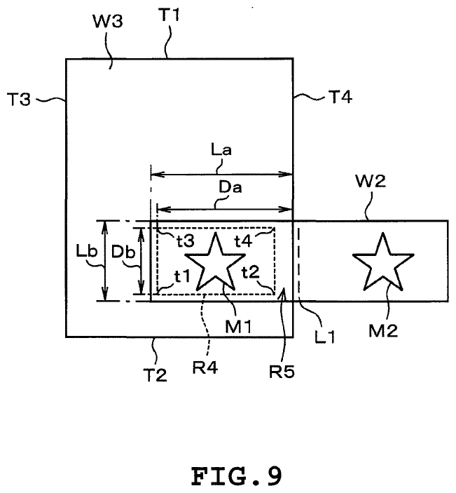

Also, the template sheet W2 illustrated by example in FIG. 9 is a type which sandwiches the workpiece W3 from the side of the edge T4. In this case, the control device 31 identifies a distance Da between an edge (an edge t1 or edge t3 on the side opposite the edge T4, in this case) of the embossing region R4 and an edge (the edge T4, in this case) of the workpiece W3 as well as a distance Db between the edge t1 and edge t3 of the embossing region R4. Then, the control device 31 multiplies the length La obtained by offsetting the distance Da by a predetermined amount and a length Lb obtained by offsetting the distance Db by a predetermined amount by each other, and thereby calculates the area of the template sheet coverage region R5 including the embossing region R4.

As described above, the control device 31 calculates the area of the template sheet coverage region R5 using each of the edges T1 to T4 of the workpiece W3 as a reference edge. Then, the control device 31 compares the areas of the template sheet coverage region R5 calculated for the respective edges T1 to T4 and selects that one of the edges T1 to T4 which minimizes the area as a reference edge.

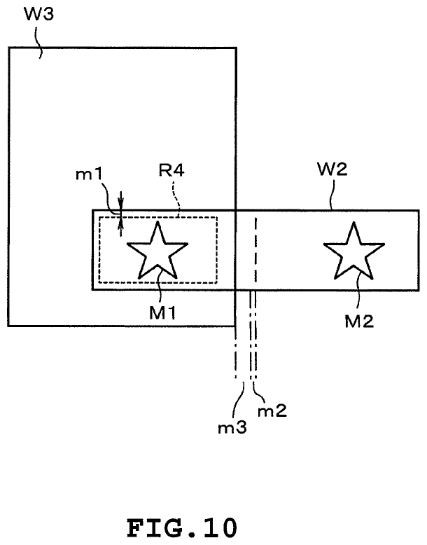

Next, description will be given of an example of setting margins of various parts provided on the template sheet W2. In the setting example shown in FIG. 10, a margin m1 is secured between outlines of the template sheet W2, i.e., visible outlines, and outlines of the embossing region R4. Note that the margin m1 may be set either equal to or different from the amount of offset used in offsetting the distance Da or distance Db described above. The margin m2 is used to absorb thickness of the workpiece W3 sandwiched by the template sheet W2. That is, when the margin m2 is provided, even if the workpiece W3 having a thickness is sandwiched by the template sheet W2 bent along the bending reference line L1, displacement between the cutting region R2 in the shape of the emboss pattern cut in the template sheet W2 and the cutting region R2 in the shape of the inverted pattern becomes less liable to occur, allowing the workpiece W3 to be aligned appropriately for embossing. The margin m3 is provided to absorb errors caused by user operation. For example, the margin m3 can absorb errors caused by user operation in adjusting a frame F1 or frame F2, errors caused by user operation in adjusting the placement location, size, orientation, or the like of a pattern, and other errors. Note that the margins are set to a predetermined length, which is, for example, 3 mm. The user may be allowed to change the margins as appropriate.

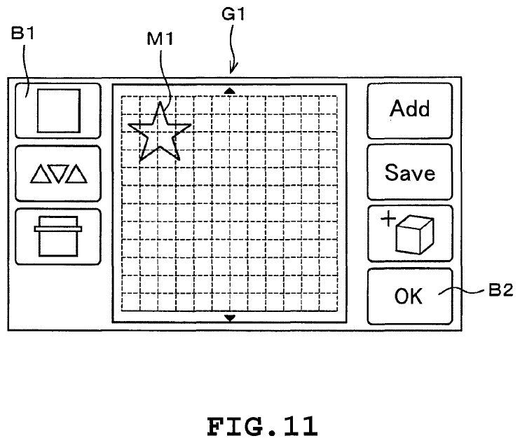

Next, description will be given of the operation of generating the template sheet W2 using the processing apparatus 1 as well as of the operation of forming an emboss pattern on the workpiece W3 using the generated template sheet W2. The screen illustrated by example in FIG. 11 is a mat layout screen G1, which is provided with various operation buttons including an emboss pattern selection button B1 and OK button B2. When the emboss pattern selection button B1 is pressed by the user, plural emboss patterns stored in the storage unit 24 are selectably displayed on an emboss pattern selection screen (not shown). When an emboss pattern M1 is selected by the user via the emboss pattern selection screen, the emboss pattern M1 is displayed on the mat layout screen G1.

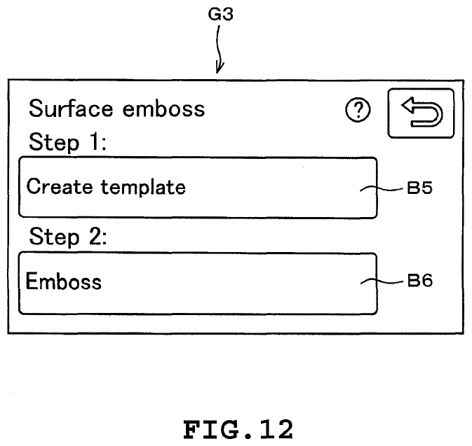

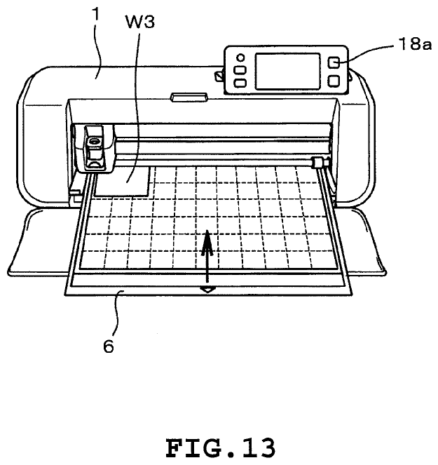

When the OK button B2 is pressed by the user, a surface embossing operation selection screen G3 illustrated by example in FIG. 12 is displayed on the display 19. Note that the surface embossing is an embossing mode for forming an emboss pattern by pressing the workpiece W3 in a planar fashion. According to the present embodiment, the embossing mode involves pressing the contour of the offset region R3 with an embossing pen from above the workpiece W3 placed on the cutting region R2 provided on the template sheet W2 and thereby turning the region into a recess having a planar bottom surface, where the offset region R3 is obtained by offsetting the cutting region R2 toward the inner side of the region by a predetermined amount. The surface embossing operation selection screen G3 is provided with a Create template button B5 and an Emboss button B6. Then, the user presses the Create template button B5 and sets the workpiece W3 placed on the holding member 6 on the processing apparatus 1 as illustrated by example in FIG. 13. Then, when a scan button B18a is pressed by the user, the scanner unit 21 starts a scan operation.

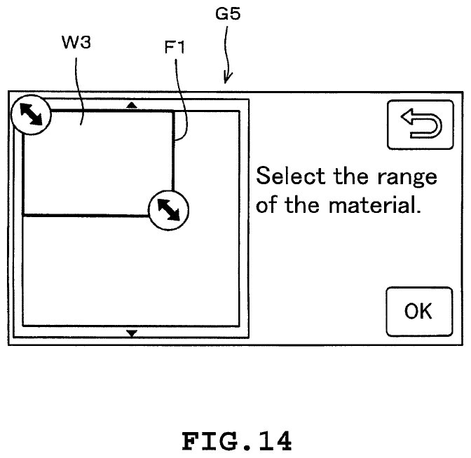

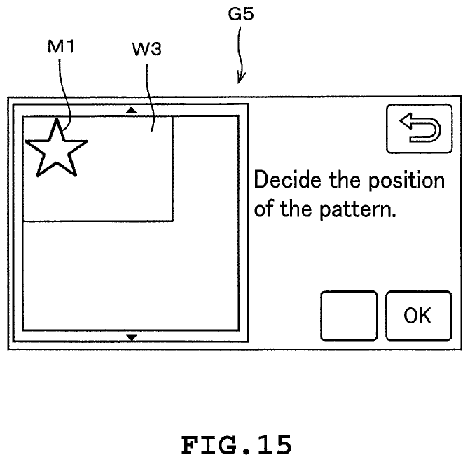

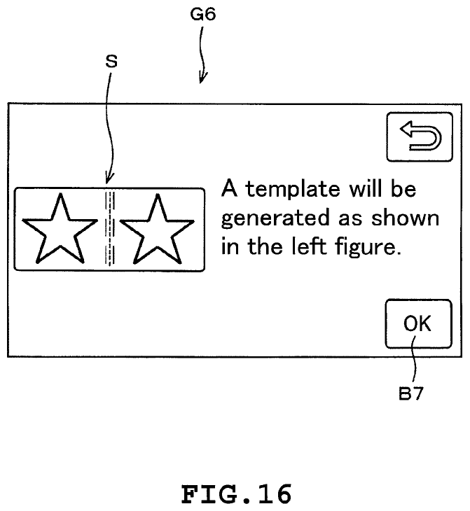

When the scan operation is completed, a scan screen G5 illustrated by example in FIG. 14 is displayed on the display 19. The scan screen G5 displays an overall image of the holding member 6 including the workpiece W3, the image having been obtained by the scan operation. On the scan screen G5, the user resizes the frame F1 to fit the workpiece W3. Then, when the adjustment of the frame F1 is completed, as illustrated by example in FIG. 15, the emboss pattern M1 specified via the emboss pattern selection screen is displayed on the scan screen G5. In so doing, the user can adjust the position, size, orientation, and the like of the emboss pattern M1 relative to the workpiece W3 on the scan screen G5. Then, when the adjustment of the emboss pattern M1 is completed, a template sheet confirmation screen G6 illustrated by example in FIG. 16 is displayed on the display 19. Note that a symbol mark S illustrated by example on the template sheet confirmation screen G6 corresponds to a template sheet W2 of the type which sandwiches the workpiece W3 when the edge which minimizes the template sheet coverage region R5 described above is selected as a reference edge.

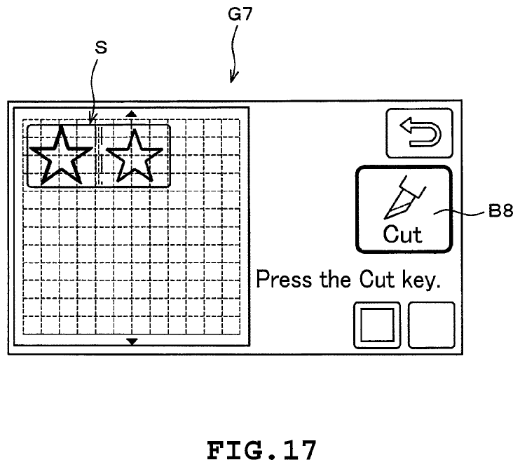

The template sheet confirmation screen G6 displays the symbol mark S of the template sheet W2 to be generated. Then, when the user presses an OK button B7 provided on the template sheet confirmation screen G6, the template sheet W2 to be generated is decided. Then, a template sheet generation screen G7 illustrated by example in FIG. 17 is displayed on the display 19. The template sheet generation screen G7 displays the symbol mark S of the template sheet W2 to be generated. By moving the displayed symbol mark S, the user can adjust cutting position of the template sheet W2 on the template sheet base material W1 held by the holding member 6.

Next, the user removes the workpiece W3 from the holding member 6 and places the template sheet base material W1 on the holding member 6. Then, the user sets the holding member 6 on the processing apparatus 1. Then, when a Cut button B8 provided on the template sheet generation screen G7 is pressed by the user, by controlling various transfer mechanisms based on the adjusted cutting position and the cut data, the processing apparatus 1 starts cutting to cut a template sheet from the template sheet base material W1. Then, when the cutting is finished, the display 19 displays the surface embossing operation selection screen G3 illustrated by example in FIG. 12. Also, the user removes remnants of the template sheet base material W1 from the holding member 6. This provides the template sheet W2 illustrated by example in FIG. 4.

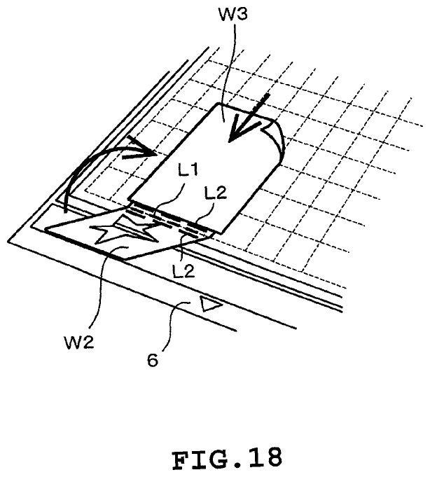

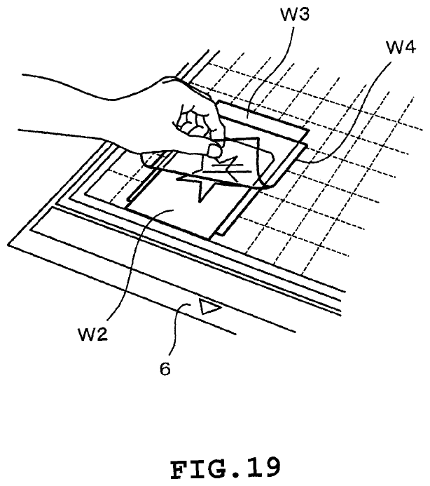

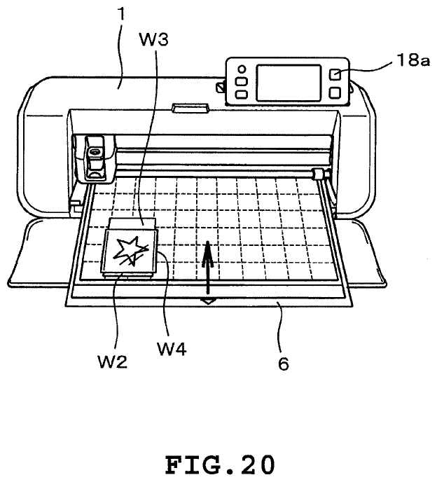

When the generation of the template sheet W2 is completed, as illustrated by example in FIG. 18, the user pastes the template sheet W2 by aligning the bending reference line L1 of the template sheet W2 with one side of the pasting region R1 of the holding member 6. Then, the user places the workpiece W3 on the template sheet W2. In so doing, the user aligns an edge of the workpiece W3 with the alignment reference line L2. Then, as illustrated by example in FIG. 19, the user bends the template sheet W2 along the bending reference line L1, sandwiching the workpiece W3, and pastes a transparent support sheet W4, thereby covering the template sheet W2. The support sheet W4 prevents the part of the bent template sheet W2 which is not pasted to the holding member 6 from rising. Then, as illustrated by example in FIG. 20, the user sets the holding member 6 holding the template sheet W2, workpiece W3, and support sheet W4 on the processing apparatus 1. Then, when the user presses the embossing button B6, and then the scan button B18a on the surface embossing operation selection screen G3, the scanner unit 21 starts a scan operation. Consequently, the holding member 6 including the template sheet W2, workpiece W3, and support sheet W4 is read, and an image thereof is acquired.

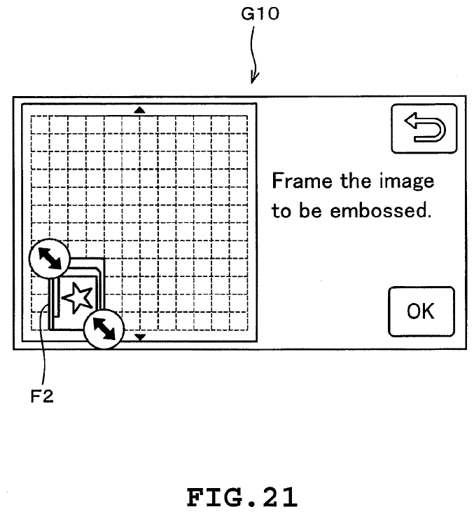

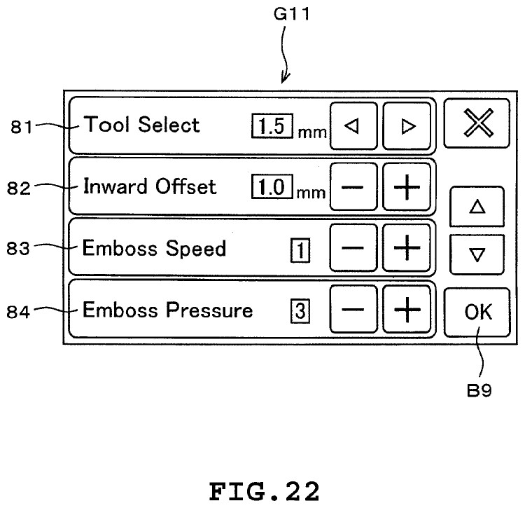

When the scan operation is completed, a scan screen G10 illustrated by example in FIG. 21 is displayed on the display 19. On the scan screen G10, the user resizes the frame F2 to fit the template sheet W2. Then, when the adjustment of the frame F2 is completed, the setting screen G11 illustrated by example in FIG. 22 is displayed on the display 19. Various setting sections including an embossing pen setting section 81, offset amount setting section 82, processing speed setting section 83, and embossing pressure setting section 84 are provided on the setting screen G11.

Via the embossing pen setting section 81, the user can adjust the size of the diameter of the embossing pen used for embossing. In other words, the user can select the type of pen cartridge. Also, via the offset amount setting section 82, the user can adjust the amount of offset used in setting the offset region R3. Also, via the processing speed setting section 83, the user can adjust the processing speed of embossing. Also, via the embossing pressure setting section 84, the user can adjust an embossing pen pressing force for embossing.

The amount of offset corresponding to the type of embossing pen set in the embossing pen setting section 81 is read out of the storage unit 24 and displayed in the offset amount setting section 82. When the amount of offset displayed in the offset amount setting section 82 is changed by the user, the amount of offset stored in the storage unit 24, i.e., the amount of offset corresponding to the embossing pen set in the embossing pen setting section 81 is updated with the post-change offset amount.

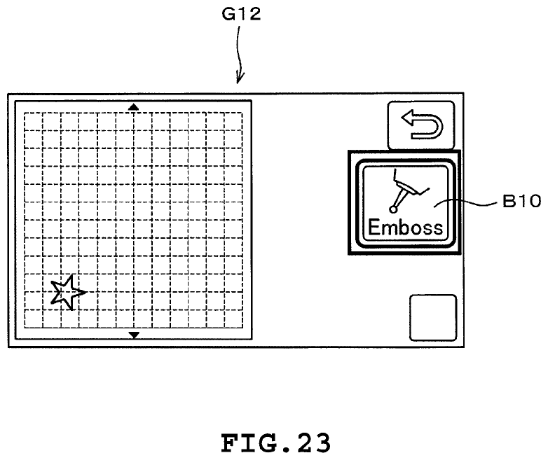

The user removes only the support sheet W4 from the holding member 6 without discharging the holding member 6, i.e., with the holding member 6 kept set on the processing apparatus 1. Then, the user spreads only an upper part of the folded template sheet W2. Then, the user mounts a pen cartridge containing an embossing pen of the diameter set via the embossing pen setting section 81 on the carriage 4. Then, when an OK button B9 provided on the setting screen G11 is pressed by the user, an embossing screen G12 illustrated by example in FIG. 23 is displayed on the display 19. Then, when an Emboss button B10 provided on the embossing screen G12 is pressed by the user, the processing apparatus 1 does embossing on the workpiece W3 by controlling various transfer mechanisms based on pressing data. Note that when a scan operation is finished, the processing apparatus 1 according to the present embodiment transports the holding member 6 to the front of the processing apparatus 1 using the pinch roller 11 and drive roller 12, and when the rollers reach a rear end of the holding member 6 after transporting the holding member 6 a predetermined distance, the processing apparatus 1 stops the transport while pinching the holding member 6. In this state, when the user operates an operation switch 20 to discharge the holding member 6, the processing apparatus 1 releases the holding member 6 from the rollers, thereby discharging the holding member 6.

Next, description will be given of an operation example of a template sheet generating process and embossing process performed by the processing apparatus 1.

### (Template Sheet Generating Process)

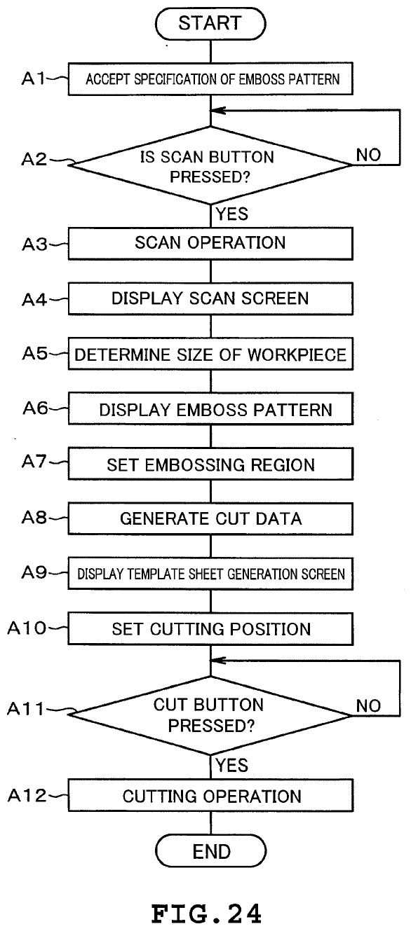

As illustrated by example in FIG. 24, upon accepting a specification operation of an emboss pattern (A1), the control device 31 monitors whether or not the scan button 18a is pressed (A2). In so doing, the user sets the holding member 6 with the workpiece W3 pasted thereto on the processing apparatus 1. Then, when the scan button 18a is pressed by the user (A2: YES), the control device 31 starts a scan operation of the holding member 6 holding the workpiece W3 (A3). Upon completion of the scan operation, the control device 31 displays the scan screen G5 (A4). Then, upon accepting an adjustment operation with respect to the frame F1 on the scan screen G5, the control device 31 identifies the size of the workpiece W3 based on the size of the frame F1 after the adjustment (A5).

Upon identifying the size of the workpiece W3, the control device 31 displays the emboss pattern M1 specified in step A1, on the scan screen G5 (A6). Then, upon accepting a change operation with respect to the position, size, orientation, and the like of the emboss pattern M1 on the scan screen G5, the control device 31 sets the region containing the emboss pattern M1 as the embossing region R4 (A7). Then, the control device 31 generates cut data for use to cut the template sheet W2 out of the template sheet base material W1 (A8). Then, the control device 31 displays the template sheet generation screen G7 (A9). Then, upon accepting an adjustment operation with respect to the symbol mark S of the template sheet via the template sheet generation screen G7, the control device 31 sets the position of the symbol mark S resulting from the adjustment as the cutting position of the template sheet (A10).

When the adjustment of the frame F1 of the workpiece W3 and the adjustment of the position of the emboss pattern M1 and the like are completed, the user takes the workpiece W3 off the holding member 6 and pastes the template sheet base material W1 to the holding member 6. Then, the user sets the holding member 6 holding the template sheet base material W1 on the processing apparatus 1. Then, when the user presses the Cut button B8 (A11: YES), based on the generated cut data and the set cutting position, the control device 31 starts generating the template sheet W2, i.e., starts the cutting operation of cutting the template sheet W2 from the template sheet base material W1 (A12).

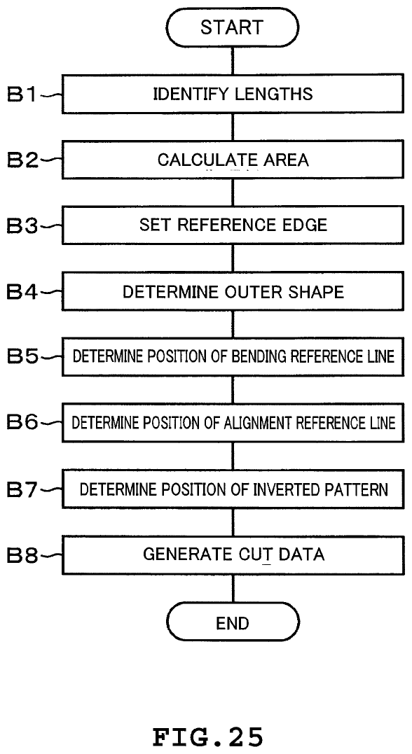

Next, an example of a cut data generating process of step A8 will be described in more detail. As illustrated by example in FIG. 25, the control device 31 identifies the lengths from the respective edges of the workpiece W3 identified in step A5 to the embossing region R4 established in step A7 (B1). Then, the control device 31 calculates the area of the template sheet coverage region R5 using each of the edges as a reference edge (B2). Then, the control device 31 sets the edge which minimizes the area of the template sheet coverage region R5 as a reference edge (B3). Then, the control device 31 determines the outer shape of the template sheet to be generated (B4).

Then, the control device 31 determines that position on the template sheet W2 at which the bending reference line L1 is to be formed (B5) and determines that position on the template sheet W2 at which the alignment reference line L2 is to be formed (B6). The control device 31 establishes a formation position of the bending reference line L1 at a position a first predetermined distance away outward from the edge of the workpiece W3 and establishes a formation position of the alignment reference line L2 at a position a second predetermined distance away outward from the edge of the workpiece W3. The second predetermined distance is shorter than the first predetermined distance, and is set equal to the above-mentioned margin m3 in this case. Also, the control device 31 determines that position on the template sheet W2 at which the inverted pattern M2 of the emboss pattern M1 is to be formed (B7). In this case, the formation position of the inverted pattern M2 is established in such a way as to be axisymmetric to the formation position of the emboss pattern M1 with respect to the bending reference line L1 serving as an axis of symmetry. Then, the control device 31 cuts the template sheet W2 in the determined outer shape, the determined emboss pattern M1, and the determined inverted pattern M2 out of the template sheet base material W1 and generates cut data for use to form the determined bending reference line L1 and the determined alignment reference lines L2 on the template sheet W2 cut out (B8). Note that steps B5, B6, and B7 may be carried out by changing their order as appropriate. Alternatively, steps B5, B6, and B7 may be carried out simultaneously.

### (Embossing Process)

When the template sheet generating process is completed, the user pastes the resulting template sheet W2 on the holding member 6. Then, the user inserts the workpiece W3 into the template sheet W2 bent along the bending reference line L1, pastes the support sheet W4 to the template sheet W2, and sets the template sheet W2 on the processing apparatus 1. Then, the user presses the scan button 18a.

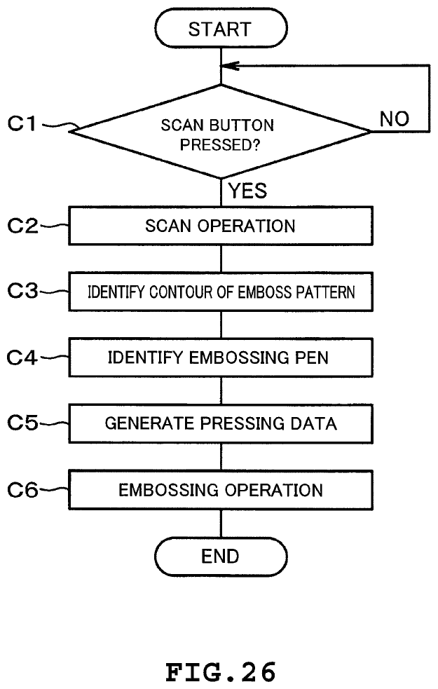

As illustrated by example in FIG. 26, after completion of the template sheet generating process, the control device 31 monitors whether or not the scan button 18a is pressed (C1). When the scan button 18a is pressed by the user (C1: YES), the control device 31 starts a scan operation with respect to the holding member 6 holding the template sheet W2, workpiece W3, and support sheet W4 (C2). The control device 31 accepts an adjustment operation with respect to the frame F2 on the scan screen G10 displaying an image represented by image data obtained by the scan operation, and within a range identified by the frame F2, identifies the contour of the emboss pattern M1 formed on the template sheet W2, in other words, the contour and position of the cutting region R2 in the shape of the emboss pattern (C3).

When the scan operation on the processing apparatus 1 is completed, the user removes only the support sheet W4 with the holding member 6 kept on the processing apparatus 1. Then, the user opens only the upper side of the template sheet W2 and mounts a pen cartridge on the carriage 4.

When a pen cartridge is mounted on the carriage 4, the control device 31 identifies the type of embossing pen on the mounted pen cartridge (C4). Then, the control device 31 generates pressing data (C5) and performs an embossing operation to emboss the workpiece W3 based on the generated pressing data (C6).

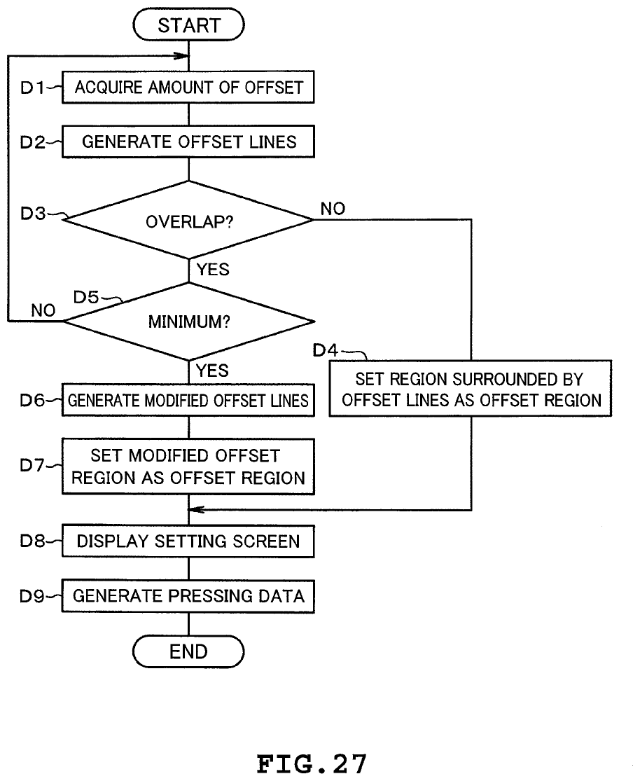

Next, an example of a pressing data generating process of step C5 will be described in more detail. As illustrated by example in FIG. 27, the control device 31 acquires the amount of offset corresponding to the type of embossing pen identified in step C4 from the storage unit 24 (D1). Then, the control device 31 virtually generates offset lines L10 by offsetting the contour of the emboss pattern M1 by the acquired amount of offset (D2). Then, the control device 31 determines whether or not the generated offset lines L10 overlap each other (D3). If the generated offset lines L10 do not overlap each other (D3: NO), the control device 31 sets the region surrounded by the offset lines L10 as the offset region R3 (D4).

If the generated offset lines L10 overlap each other (D3: YES), the control device 31 determines whether or not the diameter of the identified embossing pen is minimum (D5). Here, being “minimum” means that the embossing pen in the pen cartridge mounted on the carriage 4 has the smallest possible diameter. If the diameter of the embossing pen is not minimum (D5: NO), the control device 31 goes to step D1 and acquires the amount of offset for an embossing pen with the second smallest diameter. Then, using the newly acquired amount of offset, the control device 31, generates offset lines L10 anew (D2). In this way, if generated offset lines L10 overlap each other (D3: YES), the control device 31 repeats generating offset lines L10 anew based on the amounts of offset for embossing pens with smaller diameters. Note that it is advisable to configure the control device 31 such that when offset lines L10 generated anew no longer overlap each other, the user will be notified that the amount of offset has been changed, and be prompted to replace the pen cartridge mounted on the carriage 4 with a pen cartridge equipped with an embossing pen of the type compatible with the post-change offset amount.

Then, if the offset lines L10 generated using the amount of offset for the minimum embossing pen overlap each other (D5: YES), the control device 31 generates modified offset lines L10 to form a modified offset region R3s obtained by coupling together plural sub-regions via a line (D6). Then, the control device 31 sets the modified offset region R3s as the offset region R3 (D7). After setting the offset region R3, the control device 31 displays the setting screen G11 (D8). Then, when an OK button B9 is pressed by the user, the control device 31 generates pressing data for use to press the part of the workpiece W3 which corresponds to the newly set offset region R3 (D9).

The processing apparatus 1 according to the present embodiment makes it possible to perform the operation of generating a template sheet W2 used for embossing as well as to perform the operation of forming an emboss pattern on a workpiece W3 using the template sheet W2. Thus, the processing apparatus 1 allows the user to perform the operation of generating a template sheet W2 used for embossing and the operation of forming an emboss pattern on a workpiece W3 using the template sheet W2, continuously as a series of operations.

Also, the processing apparatus 1 identifies the position and shape of the cutting region R2 in the pressable region R1. Then, the processing apparatus 1 generates pressing data based on the identified position and shape of the cutting region R2. Consequently, when generating a template sheet W2, it is possible to accurately identify the cutting position of the template sheet base material W1, i.e., the cutting region R2 and obtain the template sheet W2 with a specified emboss pattern M1 cut out precisely.

Also, the processing apparatus 1 sets a region offset inward by a predetermined amount from the contour of the identified cutting region R2 as the offset region R3. Then, the processing apparatus 1 generates pressing data for use to press the part of the workpiece W3 which corresponds to the offset region R3. With this configuration, embossing is done along the contour of the offset region R3 on the inner side of the cutting region R2 rather than along the contour of the cutting region R2. This makes it possible to prevent the embossing pen from going up onto the template sheet W2 and give a good finish to embossing.

Also, the processing apparatus 1 adjusts the amount of offset used in setting the offset region R3 according to the type of the embossing pen mounted on the carriage 4. With this configuration, the offset region R3 can be set according to the type of embossing pen. This makes it possible to further prevent the embossing pen from going up onto the template sheet W2 and give a better finish to embossing. In this case, the processing apparatus 1 increases the amount of offset according to the diameter of the embossing pen mounted on the carriage 4. This makes it possible to further prevent the embossing pen from going up onto the template sheet W2 and give a better finish to embossing.

Also, the processing apparatus 1 identifies the position and shape of the cutting region R2 based on the images reproduced from the image data obtained by the scanner unit 21. This configuration makes it possible to identify the cutting region R2 precisely and precisely generate a template sheet W2 with an emboss pattern M1 cut out.

Also, the processing apparatus 1 sets an embossing region R4, which is that region of the workpiece W3 in which the emboss pattern M1 will be formed. Then, the processing apparatus 1 determines the length, and moreover the outer shape, of the template sheet W2 to be generated based on the distance between the embossing region R4 and the edge of the workpiece W3. Then, the processing apparatus 1 generates cut data used to cut the template sheet W2 having the determined outer shape out of the template sheet base material W1 and cut the emboss pattern M1 from the template sheet W2. This configuration makes it possible to generate the template sheet W2 with reference to the embossing region R4 to be embossed, and more precisely generate the template sheet W2 with the emboss pattern M1 cut out.

Also, the processing apparatus 1 can generate a template sheet W2 having a length equal to or longer than the distance between the embossing region R4 and the workpiece W3, the distance being determined with reference to the embossing region R4. In this case, the processing apparatus 1 forms a template sheet W2 twice or more as long as an identified distance and cuts an emboss pattern M1 and an inverted pattern M2 thereof out of the template sheet W2. This makes it possible to generate a template sheet W2 of a type which sandwiches the workpiece W3.

Also, since the types of embossing pens and amounts of offset are stored in the storage unit 24 by being associated with each other, the processing apparatus 1 can accurately set the amount of offset corresponding to the type of embossing pen based on the information stored in advance. Also, the processing apparatus 1 displays the amount of offset corresponding to the type of mounted embossing pen on the display 19. This makes it easy for the user to see to what extent the established offset region R3 is offset and thereby allows the user to adjust the offset region R3 easily. Also, when the type of embossing pen is changed, the processing apparatus 1 changes the amount of offset quickly in response to the change in the type of embossing pen, and thus the amount of offset can be adjusted quickly.

Also, with the type of embossing pen being displayed, upon accepting an offset amount change operation from the user, the processing apparatus 1 updates the amount of offset stored in the storage unit 24 by being associated with the type of embossing pen with the post-change offset amount. Thus, subsequently, offset amount adjustment can be made using the amount of offset corresponding to the change made by the user, i.e., the amount of offset in which preference of the user is reflected.

Also, the processing apparatus 1 determines whether or not set outlines of the offset region R3 overlap each other. Then, if it is determined that the outlines of the offset region R3 overlap each other, the processing apparatus 1 performs the process of changing the type of an embossing pen to be mounted on the carriage 4. This makes it possible to prevent the outlines of the offset region R3 from overlapping each other, and form a single coherent emboss pattern on the workpiece W3 as an undivided whole.

Also, if it is determined that the outlines of the offset region R3 overlap each other, the processing apparatus 1 makes the amount of offset of part in which the outlines are determined to overlap smaller than the amount of offset of part in which the outlines are determined not to overlap. In this case, by making the amount of offset of the part in which the outlines are determined to overlap smaller than the amount of offset of the part in which the outlines are determined not to overlap, the processing apparatus 1 forms a line Lc linking together two intersecting points P1 and P2 formed by the outlines in a location where the outlines of the offset region R3 overlap and sets a modified offset region R3s containing the line Lc. This makes it possible to set an offset region R3 in which the outlines are not overlapped with each other, and form a single coherent emboss pattern on the workpiece W3 as an undivided whole.

Also, the processing apparatus 1 determines the length and outer shape of the template sheet W2 to be generated based on the distances between the embossing region R4 of the workpiece W3 and the edges T1 to T4 of the workpiece W3, where the emboss pattern M1 is formed in the embossing region R4. This makes it possible to keep the size of the template sheet W2 to be generated to the minimum necessary and thereby make effective use of the template sheet base material W1. Also, by taking into consideration the distances between the embossing region R4 in which the emboss pattern M1 is formed and the edges T1 to T4 of the workpiece W3, it is possible to generate a template sheet W2 larger than the workpiece W3. This allows the user to locate the position of the template sheet W2 from above the workpiece W3 and easily identify the embossing position, making it possible to improve the ease of use of the template sheet W2.

Also, when the workpiece W3 has plural edges T1 to T4, the processing apparatus 1 selects a reference edge from the plural edges T1 to T4. In this case, the processing apparatus 1 selects the edge which minimizes the length of the template sheet W2 to be generated, in other words, the edge which minimizes the area of the template sheet coverage region R5 calculated based on the length, as the reference edge. Then, based on the distance between the selected reference edge and the edges of the embossing region R4, the processing apparatus 1 determines the length and outer shape of the template sheet W2 to be generated. This makes it possible to ensure that the size of the template sheet W2 to be generated is kept to the minimum necessary and thereby make more effective use of the template sheet base material W1. Note that when the workpiece has a shape without edges, such as a circular or elliptical shape, a rectangular shape enclosing the circular shape can be set up as an imaginary workpiece and the reference edge can be selected from the plural edges of the imaginary workpiece.

Also, the processing apparatus 1 makes it possible to generate a template sheet W2 of a type which sandwiches the workpiece W3. With this template sheet W2, the embossing position on the workpiece W3 can be identified with reference to the cutting region R2 on a folded top surface, making it easy to align the embossing position.

Also, the processing apparatus 1 allows the bending reference line L1 and alignment reference lines L2 to be formed on the template sheet W2. Thus, with reference to the reference lines L1 and L2, the template sheet W2 can be aligned with the holding member 6, and the workpiece W3 with the template sheet W2, enabling precise embossing.

Also, by identifying a workpiece holding region R6 in which the workpiece W3 is held on the holding member 6 and setting the embossing region R4 in the workpiece holding region R6, the processing apparatus 1 can precisely determine the embossing position of the workpiece W3 and give a good finish to embossing.

Note that the present disclosure is not limited only to the embodiment described above and may be altered or expanded as follows.

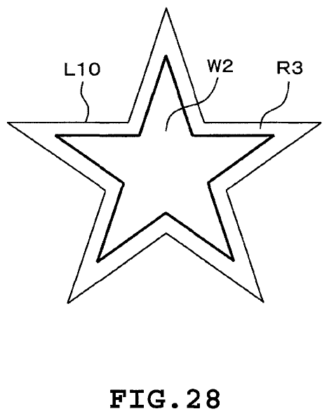

For example, as illustrated by example in FIG. 28, when embossing is done by pressing an outer side of a contour of a template sheet W2 in a predetermined shape it is advisable to set an offset region R3 which is offset outward by a predetermined amount from the contour of the template sheet W2 and generate pressing data for use to press the part of the workpiece W3 which corresponds to the offset region R3 from above with the workpiece W3 being placed on the template sheet W2.

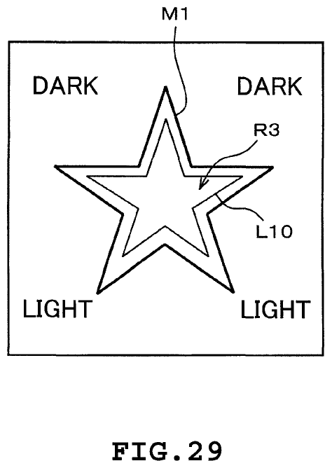

Also, as illustrated by example in FIG. 29, the amount of offset may be varied according to shading (dark or light) of a template sheet W2 around a cutting region R2 in the shape of an emboss pattern or a workpiece W3 held by the template sheet W2. In this case, the amount of offset in a light region is set larger than in a dark region. In this example, an emboss pattern can be formed on the workpiece with the dark region being pressed distinctly and the light region being pressed indistinctly.

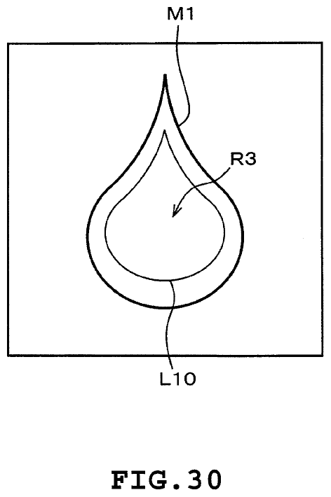

Also, as illustrated by example in FIG. 30, the amount of offset may be varied according to the shape of the emboss pattern M1. In this case, the amount of offset is set larger in a gently angled shape than in a sharply angled shape. In this example, an emboss pattern can be formed on the workpiece with the sharply angled shape being pressed distinctly and the gently angled shape being pressed indistinctly.

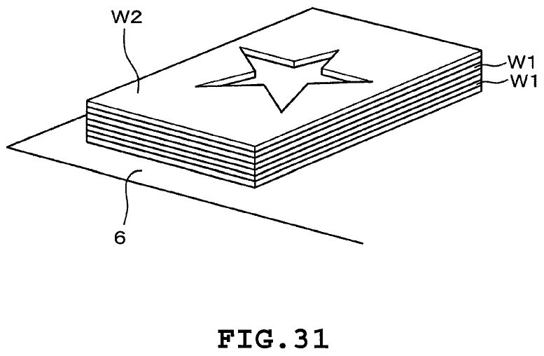

As illustrated by example in FIG. 31, it is advisable that the holding member 6 is constructed by laminating a large number of pieces of the template sheet base material W1. With this holding member 6 the template sheet W2 cut by a cutting process can be held as-cut. Thus, during embossing, the user can set the workpiece W3 at the position where the template sheet W2 was cut. Therefore, if the position where the template sheet W2 was cut and the emboss pattern M1 are memorized, the processing apparatus 1 can perform embossing at the memorized cutting position by using a region offset inward by a predetermined amount from the contour of the emboss pattern M1 as a pressing position. Also, if a template sheet W2 once generated becomes unnecessary, another template sheet W2 can newly be generated by taking off and removing the unnecessary template sheet W2.

Also, the image data acquisition processing unit 59 may be configured to acquire image data using a camera rather than the scanner unit 21. Also, the support sheet W4 may be used as needed. Also, a template sheet W2 with an emboss pattern M1 and an inverted pattern M2 thereof cut out may be obtained by bending the template sheet base material W1 and cutting the emboss pattern M1. An example in which the cutting processing unit 52 cuts the outer shape of the template sheet W2 and the emboss pattern M1 simultaneously out of the template sheet base material W1 has been disclosed in the present embodiment. However, the cutting processing unit 52 may be configured to cut the outer shape of the template sheet W2 from the template sheet base material W1 first, and then cut the emboss pattern M1. Alternatively, the cutting processing unit 52 may be configured to cut the emboss pattern M1 out of the template sheet base material W1 first, and then cut the outer shape of the template sheet W2.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

1. An embossing apparatus which forms an emboss pattern on a sheet-type workpiece, comprising:
a mounting unit on which an embossing pen for embossing is mounted;
a transfer mechanism configured to move the workpiece and the mounting unit relative to each other; and
a controller configured to control the transfer mechanism,
the controller being configured to control the embossing apparatus to:
identify a contour of a predetermined shape,
set a region offset inward or outward by a predetermined amount from the identified contour of the predetermined shape as an offset region,
generate pressing data for use to press part of the workpiece which corresponds to the set offset region, and
press the workpiece with the embossing pen according to the generated pressing data.

2. The embossing apparatus according to claim 1, wherein a plurality of types of embossing pens differing in diameter are able to be mounted on the mounting unit,
the controller being configured to further control the embossing apparatus to:
identify a type of the embossing pen mounted on the mounting unit,
set an amount of offset used in setting the offset region according to the identified type of the embossing pen, and
set a region offset inward or outward by the set amount of offset from the identified contour of the predetermined shape as the offset region.

3. The embossing apparatus according to claim 2, the controller being configured to further control the embossing apparatus to increase the amount of offset according to a diameter of the identified embossing pen.

4. The embossing apparatus according to claim 2, further comprising:
a storage unit configured to store types of embossing pens and amounts of offset by associating the types of the embossing pens and the amounts of offset with each other;
a display unit configured to display the type of the embossing pen mounted on the mounting unit and the amount of offset stored in the storage unit by being associated with the type of the embossing pen; and
an operating portion configured to accept a user operation,
the controller being configured to further control the embossing apparatus to change the amount of offset displayed on the display unit upon accepting a change in the type of the embossing pen mounted on the mounting unit via the operating portion, the displayed amount of offset being changed to the amount of offset stored in the storage unit by being associated with the type of the embossing pen resulting from the change.

5. The embossing apparatus according to claim 4, the controller being configured to further control the embossing apparatus to update the amount of offset stored in the storage unit upon accepting a change in the amount of offset via the operating portion, with the type of the embossing pen being displayed on the display unit, where the amount of offset is stored by being associated with the type of embossing pen, the amount of offset being updated with the amount of offset resulting from the change.

6. The embossing apparatus according to claim 1, the controller being configured to further control the embossing apparatus to determine whether the set outlines of the offset region overlap each other.

7. The embossing apparatus according to claim 6, the controller being configured to further control the embossing apparatus to perform a notification process of prompting to change the type of the embossing pen mounted on the mounting unit in response to determining that the outlines of the offset region overlap each other.

8. The embossing apparatus according to claim 6, the controller being configured to further control the embossing apparatus to:
set a modified offset region obtained by making an amount of offset of part in which outlines are determined to overlap smaller than an amount of offset of part in which the outlines are determined not to overlap in response to determining that the outlines of the offset region overlap each other, and
generate pressing data for use to press part of the workpiece which corresponds to the modified offset region resulting from modification instead of part which corresponds to the offset region.

9. The embossing apparatus according to claim 6, the controller being configured to further control the embossing apparatus to:
set a modified offset region containing a line linking together two intersecting points formed by the outlines in response to determining that the outlines of the offset region overlap each other, the two intersecting points being formed in a location where the outlines of the offset region overlap, and
generate pressing data for use to press part of the workpiece which corresponds to the modified offset region resulting from modification instead of part which corresponds to the offset region.

10. The embossing apparatus according to claim 9, wherein the line contained in the modified offset region passes between the two outlines of the offset region in the location where the outlines overlap.

11. The embossing apparatus according to claim 1, the controller being configured to further control the embossing apparatus to:
acquire image data for reproducing an image of the template sheet with the predetermined shape cut out therefrom, and
identify the contour of the predetermined shape based on the image reproduced from the acquired image data.

12. The embossing apparatus according to claim 1, the controller being configured to further control the embossing apparatus to set the offset region by partially changing an amount of offset from the identified contour of the predetermined shape.

13. An embossing method for forming an emboss pattern on a sheet-type workpiece, comprising:
identifying a contour of a predetermined shape;
setting a region offset inward or outward by a predetermined amount from the identified contour of the predetermined shape as an offset region;
generating pressing data for use to press part of the workpiece which corresponds to the set offset region, and
pressing the workpiece according to the generated pressing data.
